(19) United States
(12) Patent Application Publication
(10) Pub. No.: US 2017/0294053 A1
(43) Pub. Date: Oct. 12, 2017

(54) METHOD, SYSTEM AND COMMUNICATION TERMINAL FOR PATROL WITH SCANNING TAGS

(71) Applicant: YEON TECHNOLOGIES CO., LTD., Taipei City (TW)

(72) Inventors: Kuo-Feng KAO, Taipei City (TW); Chih-Ting CHUEH, Taipei City (TW); Chih-Wei HOU, Taipei City (TW)

(21) Appl. No.: 15/155,075

(22) Filed: May 16, 2016

(30) Foreign Application Priority Data
Apr. 7, 2016 (TW) 105110872

(51) Int. Cl. G07C 1/20; G06K 19/06; G06K 19/077; G06K 7/10; G06Q 10/06

(52) U.S. Cl. CPC G07C 1/20; G06K 7/10366; G06Q 10/063114; G06K 19/07786; G06K 19/06037

(57) ABSTRACT

A method for patrol with scanning tags includes: installing electronic tags in various patrol locations, each of which includes an electronic paper displaying module and an identification mark mapping to one of the patrol locations to form mapping information; logging in a patrol server with a communication terminal; downloading a patrol route list which lists multiple patrol locations from the patrol server; scanning, with the communication terminal, the identification mark on the electronic tag when arriving at one of the patrol locations; and transmitting, with the communication terminal, a first data signal to the electronic tag to display a first patrol record based on the first data signal, and confirming the patrol position to be checked by transmitting the first patrol record to the patrol server.

### BACKGROUND OF THE INVENTION

1. Field of the Invention

The present invention relates to instant messaging (IM), and more particularly, to a method, a system, and a communication terminal for patrol with scanning tags.

2. Description of the Prior Art

With the advancement and sophistication of the society, the public are more aware of personal and environmental safety. So the safety service covers wider aspects, such as theft, disaster, healthcare, energy saving and so on, and takes a more and more important role. The conventional safety system is to arrange the safety guard to patrol every patrol location and to ask the safety guard to handwrite their names and arriving time on the attendance cards at each patrol location.

However, the conventional method for patrol has some problems to be resolved. For example, a lot of attendance cards are necessary at each patrol location when patrol locations are a lot, which causes paper waste and sheet management cost. Or, if the patrol staff do not record sign-up time correctly, other people are unable to know the real arrival time of the patrol staff. In this way, abnormal patrol sheets fail to be tracked or improved effectively and instantly.

With the development of the instant messaging application, the patrol staff can send and read voice messages, videos, pictures, and letters/characters on the cellphones through the network. Therefore, applying instant messaging to the patrol system is the trend nowadays.

### SUMMARY OF THE INVENTION

The present invention proposes a method, a system, and a communication terminal for patrol with scanning tags. The patrol staff instantly download a patrol route list which lists multiple patrol locations from the patrol server, scan, with the communication terminal, the identification mark on the electronic tag when arriving at one of the patrol locations, and confirm the patrol position to be checked.

According to the present invention, a method for patrol with an electronic tag comprises steps of: installing an electronic tag in a patrol location, the electronic tag comprising an electronic paper displaying module and an identification mark, the identification mark mapping to the patrol location to form mapping information, and the mapping information being stored in a patrol server; logging in to the patrol server through a communication terminal; downloading a patrol route list which lists a plurality of patrol locations, a plurality of patrol slots, a plurality of patrol orders, and a plurality of identification marks mapping to the plurality of patrol locations from the patrol server; scanning the identification mark on the electronic tag at the patrol location with the communication terminal when arriving at one of the plurality of patrol locations; and transmitting a first data signal to the electronic tag with the communication terminal based on the wireless communication technology when the scanned identification mark maps to the mapping information recorded in the patrol server, showing a first patrol record with the electronic tag based on the first data signal, sending back the first patrol record to the patrol server with the communication terminal to confirm the completion of patrol of the patrol location at the same time, and the first patrol record comprising arrival time of the patrol staff, identification of the patrol staff, the patrol locations, and patrol results.

In one aspect of the present invention, the identification mark is a bar code or a radio frequency identification (RFID) chip.

In another aspect of the present invention, the method further comprises a step of: scanning an identification mark on a newly added electronic tag with the communication terminal, setting the newly added electronic tag to map to a newly added patrol location, and transmitting the identification mark on the newly added electronic tag and the newly added patrol location mapping to the newly added electronic tag to the patrol server through the network.

In another aspect of the present invention, the method further comprises a step of: editing the patrol route list with the communication terminal.

In still another aspect of the present invention, the method further comprises a step of: sending back a second patrol record to the patrol server with the communication terminal when the patrol location is abnormal, transmitting a second data signal to the electronic tag with the communication terminal at the same time, and showing a second patrol record on the electronic paper displaying module with the electronic tag according to the second data signal, wherein the second patrol record comprising arrival time of the patrol staff, identification of the patrol staff, the patrol locations, and abnormalities.

In yet another aspect of the present invention, the wireless communication technology comprises the near field communication (NFC) technique or the ultra high frequency (UHF) technique.

According to the present invention, a communication terminal comprises a reader for reading an identification mark on an electronic tag, the identification mark mapping to a patrol location for forming mapping information, a radio frequency functional module, a transmitting module, a processor, and a memory connected with the processor. The memory comprises a plurality of program instructions executable by the processor. The plurality of program instructions comprises a synchronization unit and a checking unit. The synchronization unit is configured to cause the processor to download a patrol route list from a patrol server, the patrol route list comprising a plurality of patrol locations, a plurality of patrol slots, a plurality of patrol orders, and a plurality of pieces of mapping information of the patrol location corresponding to the identification mark and send back a first patrol record to the patrol server to check the completion of patrol of the patrol location, or configured to cause the processor to send back a second patrol record to the patrol server with the communication terminal when the patrol location is abnormal. The checking unit is configured to cause the processor to check whether the read identification mark maps to the mapping information recorded in the patrol server. The radio frequency functional module transmits a first data signal to the electronic tag showing the first patrol record according to the first data signal with the communication terminal when the scanned identification mark maps to the mapping information recorded in the patrol server, or transmits a second data signal to the electronic tag showing the second patrol record according to the second data signal with the communication terminal when the patrol location is abnormal. The transmitting module is used for performing an act of the synchronization unit downloading the patrol route list and sending back the first patrol record and the second patrol record.

In one aspect of the present invention, the identification mark is a bar code or a radio frequency identification (RFID) chip.

In another aspect of the present invention, the communication terminal further comprises a setting unit, configured to cause the processor to set a newly added electronic tag mapping to a patrol location to form mapping information when the reader reads an identification mark on the newly added electronic tag and to transmit the mapping information to the patrol server by the transmitting module.

In still another aspect of the present invention, the communication terminal further comprises an editing unit, configured to cause the processor to edit the patrol route list downloaded from the patrol server.

In yet another aspect of the present invention, the radio frequency functional module adopts the near field communication (NFC) technique or the ultra high frequency (UHF) technique.

According to the present invention, a patrol system comprises an electronic tag, a patrol server, and a communication terminal. The electronic tag comprises an electronic paper displaying module and an identification mark mapping to a patrol location to form mapping information. The patrol server is used for storing a patrol route list. The patrol route list comprises a plurality of patrol locations, a plurality of patrol slots, a plurality of patrol orders, and a plurality of identification marks mapping to the plurality of patrol locations. The communication terminal downloads the patrol route list from the patrol server through the network and edit the patrol route list, scans the identification mark on the electronic tag with the communication terminal when the patrol staff arrive at one of the patrol locations, sends back a first patrol record to the patrol server with the communication terminal when the scanned identification mark maps to the mapping information recorded in the patrol server, transmits a first data signal to the electronic tag through the wireless communication technology with the communication terminal, shows the first patrol record according to the first data signal to check the completion of patrol of the patrol location with the electronic tag, or transmits a second patrol record recorded in the patrol server with the communication terminal when the patrol location is abnormal, and transmits a second data signal to the electronic tag showing the second patrol record according to the second data signal at the same time with the communication terminal through the wireless communication technology.

In one aspect of the present invention, the identification mark is a bar code or a radio frequency identification (RFID) chip.

In another aspect of the present invention, the communication terminal is further used for scanning an identification mark on a newly added electronic tag, setting mapping information produced by the newly added electronic tag corresponding to a patrol location, and transmitting the mapping information to the patrol server.

In another aspect of the present invention, the first patrol record comprises arrival time of the patrol staff, identification of the patrol staff, the patrol locations, and the patrol results.

In still another aspect of the present invention, the second patrol record comprises arrival time of the patrol staff, identification of the patrol staff, the patrol locations, and abnormalities.

In yet another aspect of the present invention, the wireless communication technology comprises the near field communication (NFC) technique or the ultra high frequency (UHF) technique.

Compared with the conventional technology, a method, a communication terminal, and a system for instant patrol is proposed in the present invention. The patrol staff download a patrol route list from a patrol server and scan, with the communication terminal, the identification mark on the electronic tag when arriving at one of the patrol locations to finish patrol. Meanwhile, the patrol staff can scan, with the communication terminal, the identification mark on a newly added electronic tag, create the patrol location of the newly added electronic tag, transmit, with the communication terminal, the identification mark on the newly added electronic tag and the patrol location of the newly added electronic tag to the patrol server, and edit the patrol route list. Therefore, it is very convenient for the patrol staff because the patrol staff scan the identification mark on the electronic tag through the communication terminal and complete the patrol. Also, the patrol staff inquire and edit the patrol route list more effectively. Moreover, the patrol staff using different communication terminals can edit and inquire the patrol route list adopting the method for instant patrol and the patrol system proposed by the present invention, which is more convenient for the patrol staff to administer the patrol route list. Compared with the conventional technology where the conventional paper tags are merely used for sign-up, the electronic tags used for the patrol system proposed by the present invention can show patrol records or abnormalities by the electronic paper displaying module. In addition, the electronic tags do not need batteries so costs of batteries and workforce exchanging batteries are avoided.

These and other features, aspects and advantages of the present disclosure will become understood with reference to the following description, appended claims and accompanying figures.

### BRIEF DESCRIPTION OF THE DRAWINGS

FIG. 1 is a schematic diagram of a patrol system according to one preferred embodiment of the present invention.

FIG. 2 shows the electronic tag according to the preferred embodiment of the present invention.

FIG. 3 is a block diagram of the patrol module of the communication terminal according to the preferred embodiment of the present invention.

FIG. 4 is a flowchart of the method for patrol using the scanning tags according to the preferred embodiment of the present invention.

### DETAILED DESCRIPTION OF THE PREFERRED EMBODIMENTS

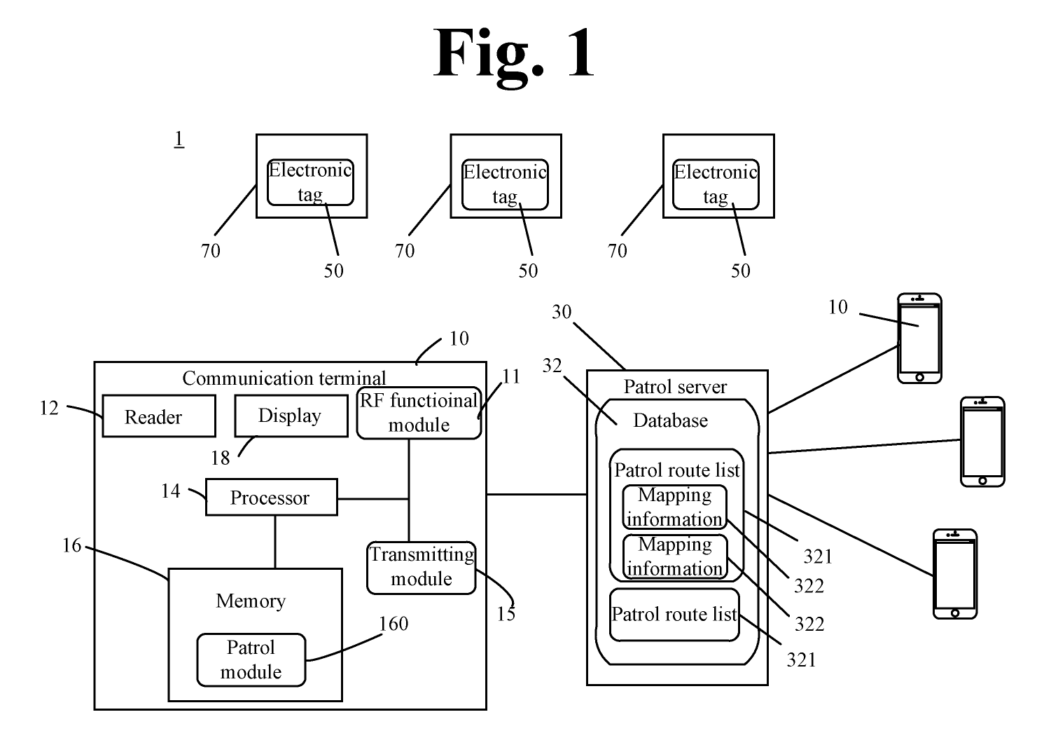

Please refer to FIG. 1. FIG. 1 is a schematic diagram of a patrol system 1 according to one preferred embodiment of the present invention. The patrol system 1 comprises a plurality of communication terminals 10, a plurality of electronic tags 50, and a patrol server 30. The plurality of electronic tags 50 are sticked to different patrol locations 70 in a district; for example, each of the floors in a building is equipped with an electronic tag 50. The plurality of communication terminals 10 are handheld electrical devices, such as tablet computers, smartphones, and palm-size computers, and communicate with the patrol server 30 through the network. The plurality of communication terminals 10 have the same structures of hardware and working principles. To simplify the description of the present invention, only one communication terminal 10 is exemplified in the following embodiments.

The communication terminal 10 comprises a radio frequency (RF) functional module 11, a reader 12, a processor 14, a transmitting module 15, a memory 16, and a display 18. The RF functional module 11 is used for transmitting wireless signals to the plurality of electronic tags 50 based on the wireless communication technology such as the near field communication (NFC) technique or the ultra high frequency (UHF) technique. The transmitting module 15 is a wireless radio frequency circuit and used for transmitting wireless signals based on the wireless radio frequency technology. The communication terminal 10 comprises a patrol module 160. The patrol module 160 is formed by a plurality of program instructions and is stored in the memory 16. The memory 16 is electrically connected to the processor 14. The plurality of program instructions stored in the patrol module 160 are executed by the processor 14 and realize various functions. The patrol server 30 stores a database 32. The database 32 records the corresponsive relations among the plurality of electronic tags 50.

The distance between the communication terminal 10 and the electronic tag 50 needs to be within ten centimeters (cm) when the RF functional module 11 adopts the NFC technique. The distance between the communication terminal 10 and the electronic tag 50 reaches three meters (m) maximally when the RF functional module 11 adopts the UHF technique. Even if the electronic tag 50 is sticked to a device located at a higher position, the communication terminal 10 will successfully read the electronic tag 50 and complete the patrol. So the work burden of the patrol staff greatly reduces.

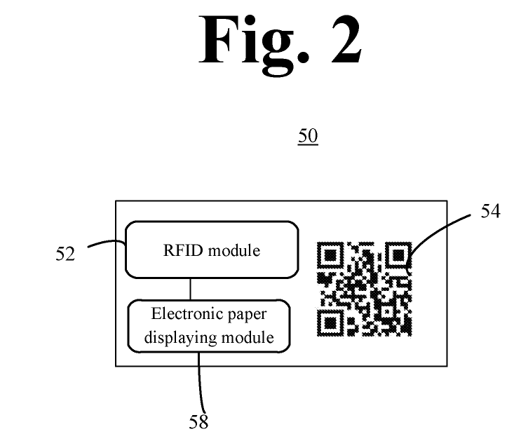

Please refer to FIG. 2 showing the electronic tag 50 according to the preferred embodiment of the present invention. The electronic tag comprises a radio frequency identification (RFID) module 52, an identification mark 54, and an electronic paper displaying module 58. The RFID module 52 is used for receiving wireless data signals transmitted and received by the RF functional module 11 in the communication terminal 10. The electronic paper displaying module 58 will transform the wireless data signals into display data and show words based on the display data upon receiving the wireless data signals.

The identification mark 54 may be a bar code, a radio frequency identification (RFID) chip, or a combination of both. The RFID chip has the advantage of not being ineffective with time easily. Preferably, each electronic tag 50 corresponds to the bar code or the RFID chip in a one to one relationship; that is, the identification mark 54 of each one electronic tag 50 is unique. Please notify that the plurality of the electronic tags 50 with the same pattern will not be deemed as identical because the identification mark 54 of each one electronic tag 50 is unique. After the plurality of the electronic tags 50 are produced, the relation of each of the produced identification marks 54 and each of the plurality of the electronic tags 50 is stored in the database 32 in the patrol server for identification.

The bar code can be a two-dimensional bar code (2D bar code), such as quick response code (QR code), or a one-dimensional bar code (1D bar code). Compared with the 1D bar code, the 2D bar code has merits of larger information capacity, unspecific reading method, and no limitations on size and color. In addition, the bar code is disposable for avoiding plagiarism for the sake of safety. Disposable bar codes can be discarded after being used once or expired. So, disposable bar codes are much safer in general.

The patrol process in this embodiment of the present invention is implemented by the identification mark 54 on the electronic tag 50. Specifically, the electronic tag 50 is a near field communication (NFC) label, an ultra high frequency (UHF) label, or a radio frequency Identification (RFID) label. The identification mark 54 maps to the patrol location 70 to form mapping information 322. The mapping information 322 comprises the name of the patrol location 70 such as “Room Y, Floor X, Building A.”

The patrol server 30 may be a server, multiservers, or a server adopting the cloud computing technique. The patrol server 30 is connected to the communication terminal through one network or a plurality of networks such as the mobile communication network, or the wireless local area network. The database 32 of the patrol server 30 is further used for storing the plurality of patrol route lists 321. Each of the patrol route lists 321 comprises a plurality of patrol locations 70, a plurality of patrol slots, a plurality of patrol orders, and a plurality of mapping information of the patrol location 70 corresponding to the identification mark 54.

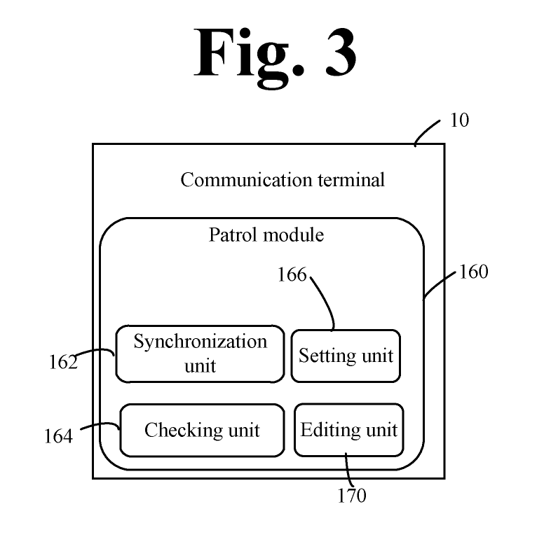

Please refer to FIG. 3. FIG. 3 is a block diagram of the patrol module 160 of the communication terminal 10 according to the preferred embodiment of the present invention. The patrol module 160 comprises a synchronization unit 162, a checking unit 164, a setting unit 166, and an editing unit 170. The synchronization unit 162, the checking unit 164, the setting unit 166, and the editing unit 170 are all written by program instructions. The patrol module 160 executes different functions with the processor 14.

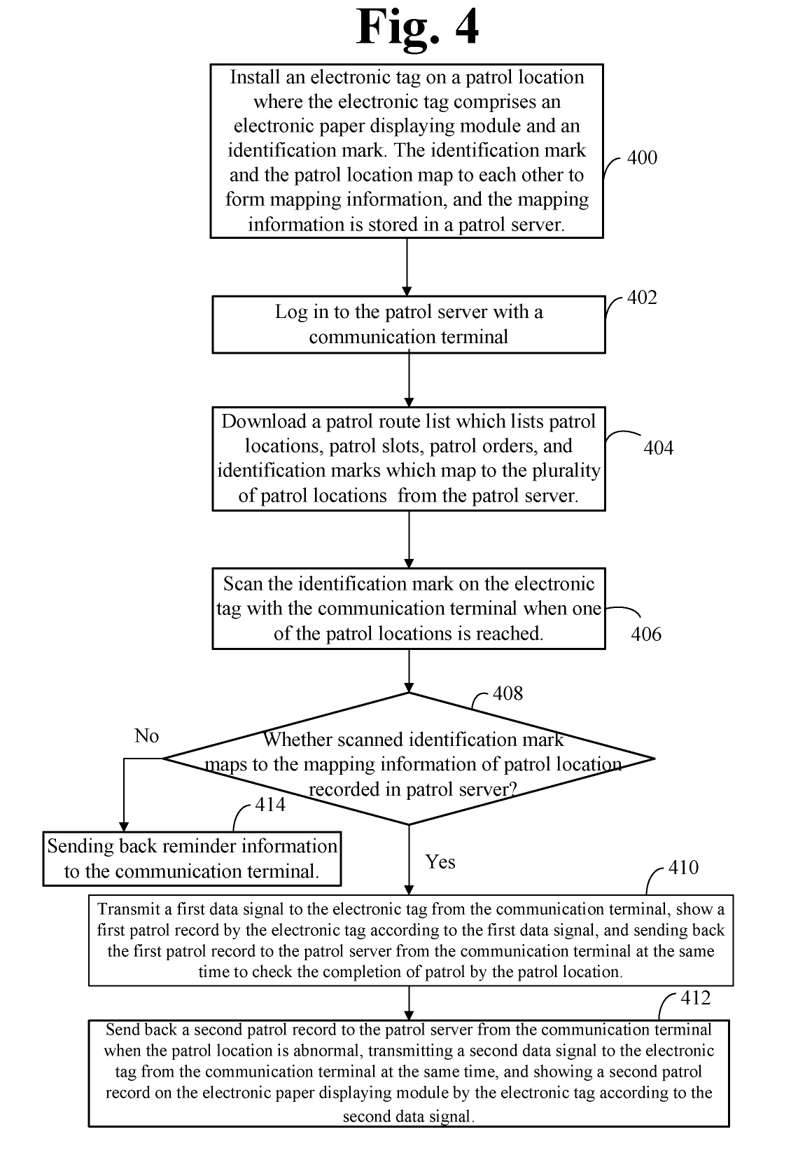

Please refer to FIG. 4. FIG. 4 is a flowchart of the method for patrol using the scanning tags according to the preferred embodiment of the present invention. The method comprises steps of:

Step 400: Installing an electronic tag 50 on a patrol location 70 where the electronic tag 50 comprises an electronic paper displaying module 58 and an identification mark 54, the identification mark 54 and the patrol location 70 map to each other to form mapping information, and the mapping information is stored in a patrol server 30.

Step 402: Logging in to the patrol server 30 with a communication terminal 10.

Step 404: Downloading a patrol route list 321 which lists a plurality of patrol locations 70, a plurality of patrol slots, a plurality of patrol orders, and a plurality of identification marks 54 which map to the plurality of patrol locations 70 from the patrol server 30.

Step 406: Scanning the identification mark 54 on the electronic tag 50 of the patrol location 70, with the communication terminal 10 when one of the plurality of patrol locations 70 is reached.

Step 408: Checking whether the scanned identification mark 54 maps to the mapping information 322 of the patrol location 70 recorded in the patrol server 30.

Step 410: Transmitting a first data signal to the electronic tag 50 by the communication terminal 10 when the scanned identification mark 54 maps to the mapping information 322 of the patrol location 70 recorded in the patrol server 30, showing a first patrol record by the electronic tag 50 according to the first data signal, and sending back the first patrol record to the patrol server 30 from the communication terminal 10 at the same time to confirm the completion of patrol of the patrol location 70.

Step 412: Sending back a second patrol record to the patrol server 30 from the communication terminal 10 when the patrol location 70 is abnormal, transmitting a second data signal to the electronic tag 50 by the communication terminal 10 at the same time, and showing a second patrol record on the electronic paper displaying module 58 by the electronic tag 50 according to the second data signal.

Step 414: Sending back an alert message to the communication terminal 10 from the patrol server 30 when the scanned identification mark 54 does not map to the mapping information 322 of the patrol location 70 recorded in the patrol server 30 or when the identification mark 54 is not stored in the patrol server 30.

Please refer to FIG. 1 to FIG. 4. As Step 400 shows, at first, the electronic tag 50 is installed in each of the patrol locations 70. The electronic tag 50 comprises the electronic paper displaying module 58 and the identification mark 54. The identification mark 54 maps to the patrol location 70 to form the mapping information 322. The mapping information 322 is stored in the patrol server 30.

The user logs in to the patrol server 30 with the communication terminal 10. At this time, the interface shown by the communication terminal 10 verifies the user's identification after the user's account and password are input (Step 402).

The access to each account is different. After the user logs in to an account, the patrol server 30 provides different functions according to the user's access of the communication terminal 10. For example, the instruction of downloading a patrol route list 321 from the patrol server 30 by performing the synchronization unit 162 through the transmitting module 15 (Step 404). The patrol route list 321 comprises a plurality of patrol locations, a plurality of patrol slots, a plurality of patrol orders, and a plurality of mapping information of the patrol location 70 corresponding to the identification mark 54. If the user is given the administrative access, he/she can also edit the data of the patrol route list 321 through the editing unit 170. In other words, the user given the administrative access can designate a patrol person to take responsibility of the patrol route list 321, edit the patrol slot of the patrol route list 321 through the communication terminal 10, or edit the order of a plurality of patrol locations of the patrol route list 321. Or, the user given the administrative access scans an identification mark 54 of a newly added electronic tag 50 through the communication terminal 10, sets up a newly added electronic tag 50 mapping to a newly added patrol location 70, and transmits the identification mark 54 of the newly added electronic tag 50 and the newly added patrol location 70 to the patrol server 30 through the transmitting module 15 with the wireless network.

When the patrol staff carrying with the communication terminal 10 arrives at one of the patrol locations 70, the patrol staff use the communication terminal 10 to scan the identification mark 54 on the electronic tag 50 of the patrol location 70 (Step 406). When the checking unit 164 determines the scanned identification mark 54 to map to the mapping information recorded in the patrol server 30, the communication terminal 10 transmits a first data signal to the electronic tag 50 through the RF functional module 11. The RFID module 52 of the electronic tag 50 receives and checks the first data signal, and then the electronic paper displaying module 58 shows the first patrol record according to the first data signal. The first patrol record comprises the arrival time of the patrol staff, the identification of the patrol staff, the patrol location 70, and the patrol result. Specifically, the communication terminal 10 converts the arrival time of the patrol staff, the identification of the patrol staff, the patrol location 70, and the patrol result into the first data signal and transmits the patrol result to the RFID module 52 of the electronic tag 50 through the RF functional module 11. The RFID module 52 receives the first data signal, converts the first data signal into the first patrol record, and transmits the first patrol record to the electronic paper displaying module 58. The electronic paper displaying module 58 shows the arrival time at the patrol location 70, the identification of the patrol staff, the patrol location 70, and the patrol result according to the first patrol record.

Meanwhile, the communication terminal 10 sends back the first patrol record to the patrol server 30 by the execution synchronization unit 162 to confirm the completion of patrol of the patrol location 70 through the transmitting module 15 (Step 410).

As Step 412 shows, the communication terminal 10 sends back the instruction of the second patrol record sent back to the patrol server 30 by the execution synchronization unit 162 through the transmitting module 15 when the patrol staff find the patrol location 70 abnormal. The communication terminal 10 transmits a second data signal to the electronic tag 50 through the RF functional module 11. The RFID module 52 of the electronic tag 50 receives and checks the second data signal, and the electronic paper displaying module 58 shows the second patrol record according to the second data signal. The second patrol record shows the arrival time at the patrol location 70, the identification of the patrol staff, the patrol location 70, and the patrol result. Once something abnormally occurs at the patrol location 70, the editing unit 170 records the abnormal condition at the patrol location 70, and the patrol result will be deemed as “abnormality”.

If the checking unit 164 determines the scanned identification mark 54 not maping to the mapping information 322 of the patrol server 30 or if the arrival time at the patrol location 70 or the identification of the patrol staff does not map to the patrol route list 321, the patrol server 30 will send back the hint information (Step 414). The electronic paper displaying module 58 of the electronic tag 50 shows the arrival time at the patrol location 70, the identification of the patrol staff, or the alert massage.

Since the patrol server 30 instantly records the arrival time at the patrol location 70 and the identification of the patrol staff, the patrol system 1 monitors the patrol staff remotely. Once the patrol staff directly scan the label at each of the patrol locations 70, they finish the act of sign-up process at the same time without signature.

In another embodiment, the patrol staff given the administrative access can establish a new patrol route list 321 through the communication terminal 10. Specifically, after arriving at the patrol location 70 on the new patrol route list 321 and sticking the electronic tag 50 on the patrol location 70, the patrol staff given the administrative access can log in to the patrol server through the communication terminal 10 and scan the identification mark 54 on the electronic tag 50 of the patrol location 70. At this time, the setting unit 166 of the communication terminal 10 inputs the information of the patrol location 70 of the newly added electronic tag 50 when the reader 12 reads the identification mark 54 on the newly added electronic tag 50. A transmitting module 15 transmits the identification mark 54 on the newly added electronic tag 50 and the patrol location 70 of the newly added electronic tag 50 to the patrol server 30 through the network. The patrol server 30 records the identification mark 54 on the newly added electronic tag 50 (which is mapping to the mapping information 322) and the patrol location 70 of the newly added electronic tag 50. In other words, the patrol staff given the administrative access can establish a new patrol route list 321 through the communication terminal 10, which achieves the beneficial effect of setting the patrol route list 321 instantly.

While the present invention has been described in connection with what is considered the most practical and preferred embodiments, it is understood that this invention is not limited to the disclosed embodiments but is intended to cover various arrangements made without departing from the scope of the broadest interpretation of the appended claims.

What is claimed is:

1. A method for patrol with an electronic tag comprising steps of:
installing an electronic tag in a patrol location, the electronic tag comprising an electronic paper displaying module and an identification mark, the identification mark mapping to the patrol location to form mapping information, and the mapping information being stored in a patrol server;
logging in to the patrol server through a communication terminal;
downloading a patrol route list which lists a plurality of patrol locations, a plurality of patrol slots, a plurality of patrol orders, and a plurality of identification marks mapping to the plurality of patrol locations from the patrol server;
scanning the identification mark on the electronic tag at the patrol location with the communication terminal when arriving at one of the plurality of patrol locations; and
transmitting a first data signal to the electronic tag with the communication terminal based on the wireless communication technology when the scanned identification mark maps to the mapping information recorded in the patrol server, showing a first patrol record with the electronic tag based on the first data signal, and sending back the first patrol record to the patrol server with the communication terminal to confirm the completion of patrol of the patrol location at the same time, wherein the first patrol record comprising arrival time of the patrol staff, identification of the patrol staff, the patrol locations, and patrol results.

2. The method of claim 1, wherein the identification mark is a bar code or a radio frequency identification (RFID) chip.

3. The method of claim 1, wherein the method further comprises a step of:
scanning an identification mark on a newly added electronic tag with the communication terminal, setting the newly added electronic tag to map to a newly added patrol location, and transmitting the identification mark on the newly added electronic tag and the newly added patrol location mapping to the newly added electronic tag to the patrol server through the network.

4. The method of claim 1, wherein the method further comprises a step of: editing the patrol route list with the communication terminal.

5. The method of claim 1, wherein the method further comprises a step of:
sending back a second patrol record to the patrol server with the communication terminal when the patrol location is abnormal, transmitting a second data signal to the electronic tag with the communication terminal at the same time, and showing a second patrol record on the electronic paper displaying module with the electronic tag according to the second data signal, wherein the second patrol record comprising arrival time of the patrol staff, identification of the patrol staff, the patrol locations, and abnormalities.

6. The method of claim 1, wherein the wireless communication technology comprises the near field communication (NFC) technique or the ultra high frequency (UHF) technique.

7. A communication terminal, comprising:
a reader, for reading an identification mark on an electronic tag, wherein the identification mark mapping to a patrol location to form mapping information;
a processor;
a memory connected with the processor, the memory comprising a plurality of program instructions executable by the processor, the plurality of program instructions comprising:
a synchronization unit, configured to cause the processor to download a patrol route list from a patrol server, the patrol route list comprising a plurality of patrol locations, a plurality of patrol slots, a plurality of patrol orders, and a plurality of mapping information of the patrol location corresponding to the identification mark and to send back a first patrol record to the patrol server to confirm the completion of patrol of the patrol location, or to send back a second patrol record to the patrol server with the communication terminal when the patrol location is abnormal; and
a checking unit, configured to cause the processor to check whether the read identification mark maps to the mapping information recorded in the patrol server;
a radio frequency functional module, for transmitting a first data signal to the electronic tag showing the first patrol record according to the first data signal with the communication terminal when the scanned identification mark maps to the mapping information recorded in the patrol server, or for transmitting a second data signal to the electronic tag showing the second patrol record according to the second data signal with the communication terminal when the patrol location is abnormal; and
a transmitting module, for performing an act of the synchronization unit downloading the patrol route list and sending back the first patrol record and the second patrol record.

8. The communication terminal of claim 7, wherein the identification mark is a bar code or a radio frequency identification (RFID) chip.

9. The communication terminal of claim 7, further comprising:
a setting unit, configured to cause the processor to set a newly added electronic tag mapping to a patrol location to form mapping information when the reader reads an identification mark on the newly added electronic tag and to transmit the mapping information to the patrol server by the transmitting module.

10. The communication terminal of claim 9, wherein the communication terminal further comprises:
an editing unit, configured to cause the processor to edit the patrol route list downloaded from the patrol server.

11. The communication terminal of claim 7, wherein the radio frequency functional module adopts the near field communication (NFC) technique or the ultra high frequency (UHF) technique.

12. A patrol system, comprising:
an electronic tag, comprising an electronic paper displaying module and an identification mark, the identification mark mapping to a patrol location to form mapping information;
a patrol server, for storing a patrol route list, the patrol route list comprising a plurality of patrol locations, a plurality of patrol slots, a plurality of patrol orders, and a plurality of identification marks mapping to the plurality of patrol locations; and
a communication terminal, for downloading the patrol route list from the patrol server through the network and editing the patrol route list,
wherein when a patrol staff arrives at one of the patrol locations, he/she scans the identification mark on the electronic tag with the communication terminal, if the scanned identification mark maps to the mapping information recorded in the patrol server, sending back a first patrol record to the patrol server with the communication terminal, transmitting a first data signal to the electronic tag through the wireless communication technology with the communication terminal, and showing the first patrol record according to the first data signal by the electronic tag to confirm the completion of patrol at the patrol location, or if the patrol location is abnomal, transmitting a second patrol record recorded to the patrol server with the communication terminal, transmitting a second data signal to the electronic tag, and showing the second patrol record according to the second data signal at the same time with the communication terminal through the wireless communication technology.

13. The patrol system of claim 12, wherein the identification mark is a bar code or a radio frequency identification (RFID) chip.

14. The patrol system of claim 12, wherein the communication terminal is further used for scanning an identification mark on a newly added electronic tag, mapping the newly added electronic tag corresponding to a patrol location to form mapping information, and transmitting the mapping information to the patrol server.

15. The patrol system of claim 12, wherein the first patrol record comprises arrival time of the patrol staff, identification of the patrol staff, the patrol locations, and patrol results.

16. The patrol system of claim 12, wherein the second patrol record comprises arrival time of the patrol staff, identification of the patrol staff, the patrol locations, and abnormalities.

17. The patrol system of claim 12, wherein the wireless communication technology comprises the near field communication (NFC) technique or the ultra high frequency (UHF) technique.
